(19) United States
(12) Patent Application Publication
(10) Pub. No.: US 2021/0211561 A1
(43) Pub. Date: Jul. 8, 2021

(54) VEHICLE IMAGING APPARATUS

(71) Applicant: HONDA MOTOR CO., LTD., Tokyo (JP)

(72) Inventors: Koji Okabe, Wako-shi (JP); Kazuhiko Kameda, Wako-shi (JP); Manabu Shimizu, Wako-shi (JP); Takuro Hashimoto, Wako-shi (JP)

(21) Appl. No.: 17/137,448

(22) Filed: Dec. 30, 2020

(30) Foreign Application Priority Data
Jan. 8, 2020 (JP) 2020-001571

(51) Int. Cl. H04N 5/225; B60S 1/56; B60R 11/04

(52) U.S. Cl. CPC H04N 5/2252; B60R 11/04; H04N 5/22521; B60S 1/56

(57) ABSTRACT

A vehicle imaging apparatus is attached to a rear part of a vehicle and is directed to a vehicle rearward direction. The vehicle imaging apparatus includes: an imaging lens that faces a vehicle rearward direction; a casing that holds the imaging lens; and a flow adjustment protrusion. The flow adjustment protrusion protrudes to a vehicle downward direction from a lower position of the imaging lens of the casing.

### CROSS-REFERENCE TO RELATED APPLICATION

Priority is claimed on Japanese Patent Application No. 2020-001571, filed on Jan. 8, 2020, the contents of which are incorporated herein by reference.

### BACKGROUND

### Field of the Invention

The present invention relates to a vehicle imaging apparatus that images a rearward direction of a vehicle.

### Background

In recent years, the number of vehicles fitted with an imaging apparatus mounted on a vehicle rear part for imaging a rearward direction has increased. In this type of imaging apparatus, an imaging lens is attached to a lower position or the like of a trunk lid at the vehicle rear part such that the imaging lens faces a vehicle rearward direction. Therefore, when the vehicle travels, dust, mud water, or the like raised by a rear tire may be carried on an air flow (air flow that flows along an upper surface or a lower surface of a vehicle body and is then directed to a rear surface of a vehicle body) that is directed to the imaging lens and may be blown to an outer surface of the imaging lens. In order to solve such a problem, an imaging apparatus has been proposed which includes a cleaning means that cleans the outer surface of the imaging lens (for example, refer to PCT International Publication No. WO 2014/010578).

In the vehicle imaging apparatus described in PCT International Publication No. WO 2014/010578, a cleaning nozzle is provided on a casing that holds the imaging lens, and a cleaning fluid is sprayed to the outer surface of the imaging lens from a front end part of the cleaning nozzle. The vehicle imaging apparatus includes a cleaning fluid passage and an air passage and guides the cleaning fluid in the cleaning fluid passage toward the imaging lens by compressed air injected from the air passage.

### SUMMARY

However, in the vehicle imaging apparatus described in PCT International Publication No. WO 2014/010578, the cleaning fluid passage and the air passage need to be provided in order to clean dirt on the imaging lens, the structure becomes complicated, and the entire apparatus becomes large. Further, since equipment for guiding the cleaning fluid and the compressed air is required for the imaging apparatus, not only the product cost of the apparatus itself increases, but also the cost of the equipment added to the vehicle increases.

An aspect of the present invention provides a vehicle imaging apparatus that is capable of preventing dirt from adhering to an imaging lens by a simple configuration which a vehicle is able to be equipped with at a low cost.

A vehicle imaging apparatus according to an aspect of the present invention is a vehicle imaging apparatus that is attached to a rear part of a vehicle and is directed to a vehicle rearward direction, including: an imaging lens that faces a vehicle rearward direction; a casing that holds the imaging lens; and a flow adjustment protrusion that protrudes to a vehicle downward direction from a lower position of the imaging lens of the casing.

According to the configuration described above, when an air flow including dust, mud water, or the like that is raised by a rear tire at the time of traveling of the vehicle passes below the imaging lens and flows to a front side of the casing, the air flow is separated by the flow adjustment protrusion that protrudes downward from the casing. Thereby, a negative pressure is generated on a vehicle frontward side of the flow adjustment protrusion, and the air flow including dust, mud water, or the like is drawn to the negative pressure. As a result, it becomes difficult for dust, mud water, or the like in the air flow to adhere to the outer surface of the imaging lens.

A front end part of the flow adjustment protrusion may be located at a vehicle rearward position further than a tangent line at a lowermost point of a lens surface approximation curve that has a constant curvature and that connects an uppermost point located at an uppermost position of an outer surface of the imaging lens, the lowermost point located at a lowermost position of the outer surface of the imaging lens, and an intermediate point located at a middle position between the uppermost point and the lowermost point of the outer surface of the imaging lens.

In this case, since the front end part of the flow adjustment protrusion is located at a vehicle rearward position further than the tangent line at the lowermost point of the lens surface approximation curve, an area (a front region of the flow adjustment protrusion) where a negative pressure is generated at the time of traveling of the vehicle can be arranged at a further vehicle rearward position. Therefore, dust, mud water, or the like which will adhere to the outer surface of the imaging lens can be suctioned to the outside at a further vehicle rearward position. Accordingly, when the present configuration is employed, it is possible to further advantageously prevent dust, mud water, or the like in the air flow from adhering to the outer surface of the imaging lens.

The flow adjustment protrusion may have a substantially triangular shape in a vehicle side view and may have a substantially rectangular shape in a vehicle rear view.

In this case, since the shape in the side view of the flow adjustment protrusion is a substantially triangular shape, the air flow at the front end part of the flow adjustment protrusion is favorably separated. Further, since the shape in the rear view of the flow adjustment protrusion is a substantially rectangular shape, a negative pressure is easily generated over a wide range on a lower front side of the imaging lens. Accordingly, when the present configuration is employed, it is possible to further prevent dust, mud water, or the like in the air flow from adhering to the imaging lens.

A surface that faces a vehicle frontward side of the flow adjustment protrusion may be curved concavely toward a vehicle rearward direction from an upward direction to a downward direction.

In this case, at the time of traveling of the vehicle, a further strong separation vortex is generated on the vehicle frontward side of the flow adjustment protrusion, and a large negative pressure that absorbs dust, mud water, or the like from the outer surface of the imaging lens is easily generated. Accordingly, when the present configuration is employed, it is possible to further prevent dust, mud water, or the like in the air flow from adhering to the imaging lens.

The flow adjustment protrusion may be constituted of a separate component that is attachable to and detachable from the casing.

In this case, it is possible to remove the flow adjustment protrusion from the casing and facilitate cleaning, and it is possible to replace the flow adjustment protrusion with another flow adjustment protrusion when the flow adjustment protrusion is damaged.

The flow adjustment protrusion may be constituted of an integral component with the casing.

In this case, the flow adjustment protrusion and the casing are an integral component and therefore can be produced at a low cost by molding or the like.

An eave part that protrudes in a vehicle rearward direction further than the outer surface of the imaging lens may be arranged on a rear upper part of the casing.

In this case, at the time of traveling of the vehicle, the air flow that flows in the imaging lens direction from an upper rear part of the imaging lens hits the eave part at the rear part of the casing and is thereby decelerated. Therefore, the dust, mud water or the like included in the air flow is drawn in a decelerated state to a negative pressure part on the vehicle frontward side of the flow adjustment protrusion. Accordingly, when the present configuration is employed, it is possible to further prevent dust, mud water, or the like from adhering to the imaging lens.

According to an aspect of the present invention, by the negative pressure that is generated on the front side of the flow adjustment protrusion when the vehicle travels, it is possible to prevent dust, mud water, or the like in the air flow from adhering to the outer surface of the imaging lens. Accordingly, when an aspect of the present invention is employed, it is possible to prevent dirt from adhering to the imaging lens by a simple configuration which a vehicle is able to be equipped with at a low cost.

### BRIEF DESCRIPTION OF THE DRAWINGS

FIG. 1 is a side view of a vehicle according to an embodiment.

FIG. 2 is a side view of an imaging apparatus according to a first embodiment that is attached to a vehicle rear part.

FIG. 3 is a perspective view of the imaging apparatus according to the first embodiment.

FIG. 4 is a schematic cross-sectional view showing a positional relationship between an imaging lens and a flow adjustment protrusion of the imaging apparatus according to the first embodiment.

FIG. 5 is a side view of an imaging apparatus according to a second embodiment.

FIG. 6 is a perspective view of an imaging apparatus according to a third embodiment.

FIG. 7 is a partial cross-sectional view of a modified example of the imaging apparatus according to the third embodiment.

### DESCRIPTION OF EMBODIMENTS

Hereinafter, an embodiment of the present invention will be described with reference to the drawings. An arrow FR that indicates a frontward direction of a vehicle 1, an arrow UP that indicates an upward direction of the vehicle 1, and an arrow LH that indicates a leftward direction of the vehicle 1 are shown at an appropriate position in the drawings.

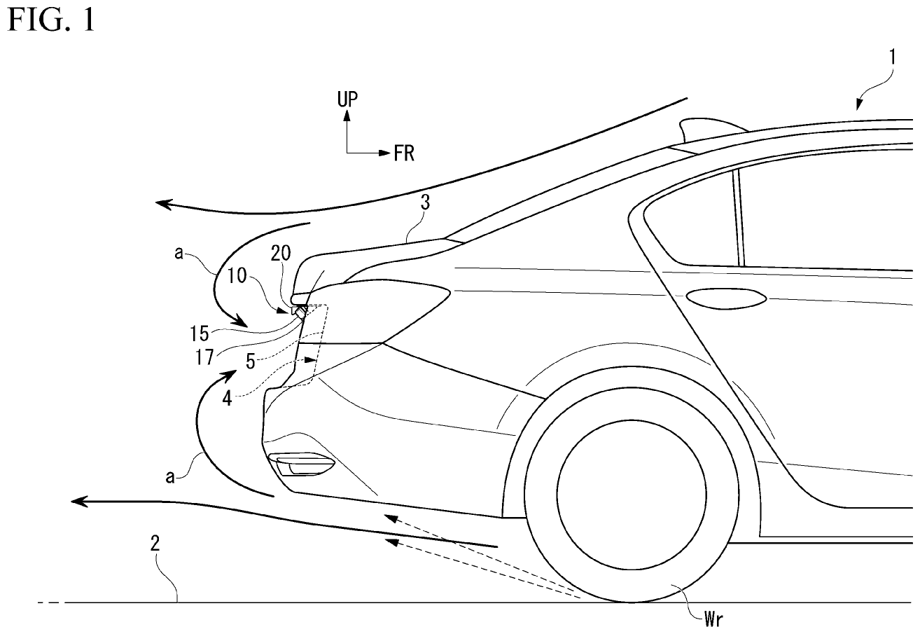

First, a first embodiment shown in FIG. 1 to FIG. 4 is described.

FIG. 1 is a side view of the vehicle 1 to which a vehicle imaging apparatus 10 (hereinafter, referred to as an “imaging apparatus 10”) according to the embodiment is attached.

The vehicle 1 is a sedan-type vehicle, and a trunk lid 3 that is openable and closeable is provided on a vehicle body rear part. Further, a recessed shape part 5 that is recessed concavely to the vehicle frontward side is provided on a rear panel 4 at the vehicle body rear part. An imaging apparatus 10 according to the embodiment is attached to the recessed shape part 5.

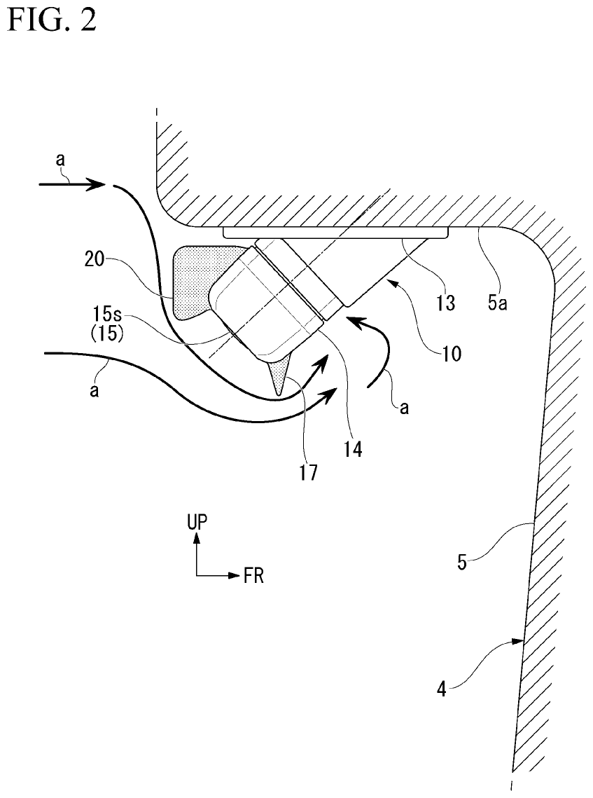

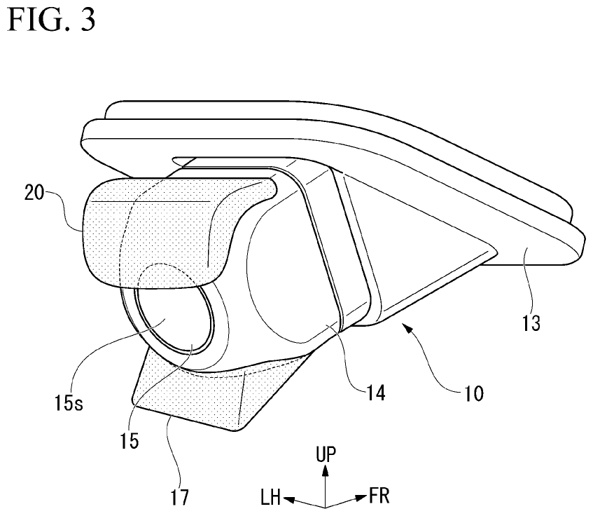

FIG. 2 is a view showing a side surface of the imaging apparatus 10 attached to the recessed shape part 5. In FIG. 2, the recessed shape part 5 is shown schematically in a cross-section. FIG. 3 is a perspective view of the imaging apparatus 10.

As shown in FIG. 2 and FIG. 3, the imaging apparatus 10 includes: an imaging lens 15 that faces a vehicle rearward direction; a casing 14 that has a substantially cylindrical shape, that holds the imaging lens 15 by a rear end part of the casing 14, and that accommodates an imaging element (not shown) and a substrate (not shown) in an inner part of the casing 14; and an attachment base 13 that supports a base part of the casing 14. The attachment base 13 is attachable to an upper wall 5a of the recessed shape part 5 at the vehicle body rear part.

The casing 14 is supported by the attachment base 13 such that the imaging lens 15 faces diagonally downward toward a vehicle rearward direction in a state where the imaging apparatus 10 is attached to a vehicle body. A flow adjustment protrusion 17 that protrudes toward a vehicle downward direction is provided to protrude at a lower position of the imaging lens 15 at the rear part of the casing 14. In the case of the present embodiment, the flow adjustment protrusion 17 is formed of a resin material integrally with the casing 14.

The flow adjustment protrusion 17 is formed in a substantially triangular shape (a substantially triangular shape in which one side is integrated with the casing 14, and one top part protrudes downward) and in a substantially rectangular shape (a rectangular shape that is elongated in a vehicle width direction) in a vehicle rear view.

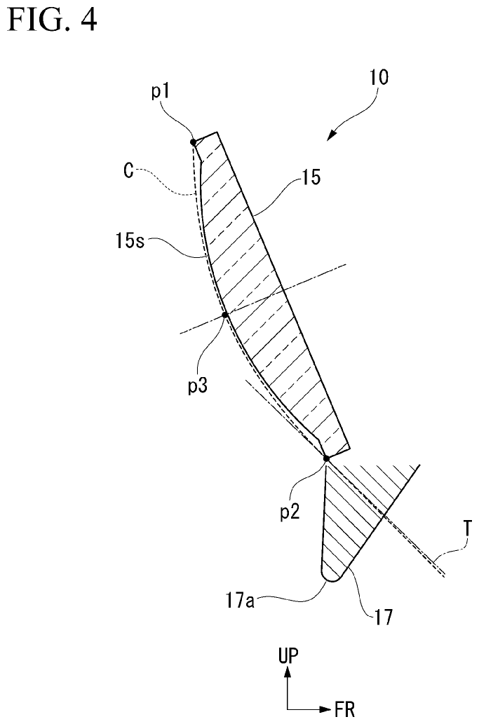

FIG. 4 is a schematic cross-sectional view of a positional relationship between the imaging lens 15 and the flow adjustment protrusion 17.

As shown in FIG. 4, in most cases, an outer surface 15s (a surface facing a vehicle rearward direction) of the imaging lens 15 is commonly not formed of a spherical surface having a constant curvature. Therefore, with respect to the outer surface 15s of the imaging lens 15, a lens surface approximation curve c having a constant curvature as shown in FIG. 4 is considered.

The lens surface approximation curve c shown in FIG. 4 is an imaginary curve that connects an uppermost point p1 located at an uppermost position of the outer surface 15s of the imaging lens 15, a lowermost point p2 located at a lowermost position of the outer surface 15s of the imaging lens 15, and an intermediate point p3 located at a middle position between the uppermost point p1 and the lowermost point p2 of the outer surface 15s of the imaging lens 15.

As shown in FIG. 4, the flow adjustment protrusion 17 protrudes downward such that a front end part 17a of the flow adjustment protrusion 17 is located at a vehicle rearward position further than a tangent line T at the lowermost point p2 of the lens surface approximation curve c.

Further, an eave part 20 that protrudes in a vehicle rearward direction further than the outer surface 15s of the imaging lens is provided to protrude at an upper position of the imaging lens 15 at the rear upper part of the casing 14. In the case of the present embodiment, the eave part 20 is formed of a resin material integrally with the casing 14. The eave part 20 is formed in a wider width (a width in the vehicle width direction) than a diameter of a part exposed to a vehicle outside of the imaging lens 15.

Next, a flow of an air flow around the imaging apparatus 10 at the time of traveling of the vehicle is described.

At the time of traveling of the vehicle 1, a traveling air flow flows rearward along an upper surface and a lower surface of the vehicle as shown in FIG. 1, and part of the traveling air flow changes the direction and flows to a rear surface side of the vehicle body. At this time, part of the air flow a directed to a vehicle rear surface side flows into the vicinity of an installation part of the imaging apparatus 10 at a vehicle body rear part. Further, dust, mud water, or the like which is raised by a rear tire Wr at the time of traveling of the vehicle 1 may flow to the vicinity of the installation part of the imaging apparatus 10 at the vehicle body rear part together with the air flow a directed to the vehicle rear surface side.

A shown in FIG. 2, the air flow a flowing to the vicinity of the installation part of the imaging apparatus 10 at the time of traveling of the vehicle is separated at a front end part of the flow adjustment protrusion 17 that protrudes downward from the casing 14 of the imaging apparatus 10 and generates a separation vortex in a space part in front of the flow adjustment protrusion 17. Thereby, a negative pressure is generated on a front side of the flow adjustment protrusion 17, and the air at a lower edge part of the flow adjustment protrusion 17 is drawn to the front side of the flow adjustment protrusion 17. As a result, it becomes difficult for the dust, mud water, or the like mixed in the air flow a to adhere to the outer surface 15s side of the imaging lens 15.

As described above, since in the imaging apparatus 10 of the present embodiment, the flow adjustment protrusion 17 is provided to project in a vehicle downward direction from a lower position of the imaging lens 15 of the casing 14, by the negative pressure that is generated on the front side of the flow adjustment protrusion 17 when the vehicle travels, it is possible to prevent dust, mud water, or the like in the air flow from adhering to the outer surface 15s of the imaging lens 15. Therefore, when the imaging apparatus 10 of the present embodiment is employed, it is possible to prevent dirt from adhering to the imaging lens 15 by a simple configuration which a vehicle is able to be equipped with at a low cost.

Further, since the front end part 17a of the flow adjustment protrusion 17 is located at a vehicle rearward side further than the tangent line T at the lowermost point p2 of the lens surface approximation curve c having a constant curvature, a front region of the flow adjustment protrusion 17 where a negative pressure is generated at the time of traveling of the vehicle can be arranged at a further vehicle rearward side. Therefore, dust, mud water, or the like which will adhere to the outer surface 15s of the imaging lens 15 can be reliably suctioned to the outside at a further vehicle rearward position.

Further, since in the imaging apparatus 10 of the present embodiment, the shape in a vehicle side view of the flow adjustment protrusion 17 is substantially a triangular shape, the air flow of the front end part of the flow adjustment protrusion 17 is favorably separated, and dust, mud water, or the like which will adhere to the outer surface 15s of the imaging lens 15 can be further reliably suctioned to the outside.

Further, since in the imaging apparatus 10 of the present embodiment, the shape in a vehicle rear view of the flow adjustment protrusion 17 is a substantially rectangular shape, a negative pressure is easily generated over a wide range on a lower front side of the imaging lens 15, and it is possible to further prevent dust, mud water, or the like in the air flow a from adhering to the imaging lens 15.

Further, in the imaging apparatus 10 of the present embodiment, the flow adjustment protrusion 17 is constituted of an integral component with the casing 14 and therefore can be produced at a low cost by resin molding or the like.

Further, in the imaging apparatus 10 of the present embodiment, the eave part 20 that protrudes in a vehicle rearward direction further than the outer surface 15s of the imaging lens 15 is provided to protrude on a rear upper part of the casing 14. Therefore, at the time of traveling of the vehicle, the speed of the air flow a flowing from an upper rear part of the imaging lens 15 in the imaging lens 15 direction can be reduced by the eave 20, and the dust, mud water, or the like included in the air flow can easily be drawn to the negative pressure on the vehicle frontward side of the flow adjustment protrusion 17. Accordingly, when the present configuration is employed, it is possible to further prevent the adhesion of dust, mud water, or the like to the imaging lens 15.

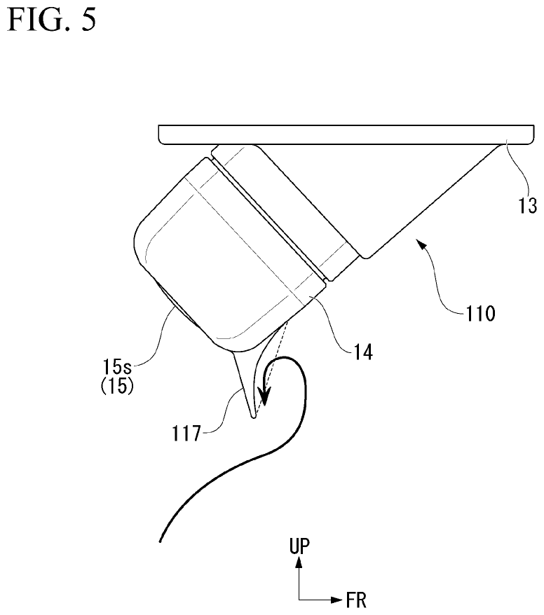

FIG. 5 is a side view of an imaging apparatus 110 according to a second embodiment. In the embodiments described below, common portions to those of the first embodiment are given by the same reference numerals, and redundant description thereof will be omitted. Further, in the following embodiments, the eave portion 20 of the first embodiment is omitted.

A basic configuration of the imaging apparatus 110 of the present embodiment is substantially similar to that of the first embodiment; however, the shape of a flow adjustment protrusion 117 that is provided to protrude at a lower rear part of the casing 14 is different from that of the first embodiment. That is, in the flow adjustment protrusion 117 of the present embodiment, a surface directed to a vehicle frontward side is curved concavely toward a vehicle rearward direction from an upward direction to a downward direction. In the flow adjustment protrusion 17 of the first embodiment, a surface facing the vehicle frontward side is formed in a linear shape in a side view as indicated by a dotted line in FIG. 5; however, in the flow adjustment protrusion 117 of the present embodiment, the surface facing the vehicle frontward side is formed in a curved line shape that is concave to the vehicle rearward side in a side view.

In the imaging apparatus 110 of the present embodiment, since the surface that faces the vehicle frontward side of the flow adjustment protrusion 117 is curved concavely toward the vehicle rearward direction from the upward direction to the downward direction, a further strong separation vortex is generated on the vehicle frontward side of the flow adjustment protrusion 117 at the time of traveling of the vehicle. Therefore, when the imaging apparatus 110 of the present embodiment is employed, a large negative pressure that absorbs dust, mud water, or the like from the outer surface 15s of the imaging lens 15 is generated at the time of traveling of the vehicle, and it is possible to further prevent dust, mud water, or the like in the air flow from adhering to the imaging lens 15.

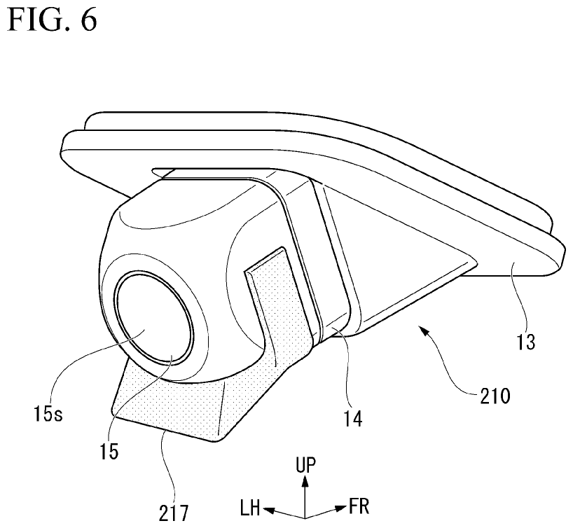

FIG. 6 is a perspective view of an imaging apparatus 210 according to a third embodiment.

A basic configuration of the imaging apparatus 210 of the present embodiment is substantially similar to that of the first embodiment; however, the imaging apparatus 210 is different from the imaging apparatus of the first embodiment in that the flow adjustment protrusion 217 that is provided to protrude at a lower rear part of the casing 14 is attached detachably from the casing 14. The flow adjustment protrusion 217 is detachably attached to the casing 14, for example, by clipping, bolt fastening, or the like.

In the imaging apparatus 210 of the present embodiment, since the flow adjustment protrusion 217 is constituted of a separate component that is attachable to and detachable from the casing 14, it is possible to remove the flow adjustment protrusion 217 from the casing 14 and facilitate cleaning, and it is possible to easily replace the flow adjustment protrusion 217 with another flow adjustment protrusion 217 when the flow adjustment protrusion 217 is damaged.

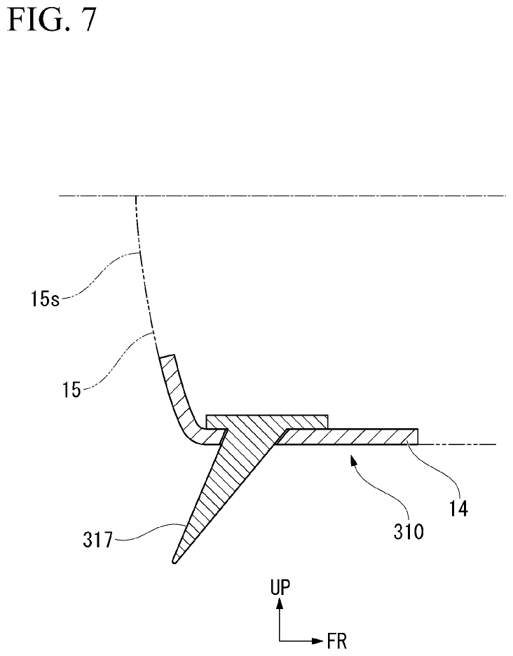

In the third embodiment shown in FIG. 6, the flow adjustment protrusion 217 is detachably attached to the outer surface of the casing 14 by clipping, bolt fastening, or the like; however, as in an imaging apparatus 310 of a modified example shown in FIG. 7, a front end part of a flow adjustment protrusion 317 that is locked to an inner part of the casing 14 may protrude to an outer part of the casing 14. In this case, it is also possible to perform the attachment and detachment of the flow adjustment protrusion 317 by disassembling the casing 14.

The present invention is not limited to the embodiments described above, and various design changes can be made without departing from the scope of the invention.

What is claimed is:

1. A vehicle imaging apparatus that is attached to a rear part of a vehicle and is directed to a vehicle rearward direction, the vehicle imaging apparatus comprising:
an imaging lens that faces a vehicle rearward direction;
a casing that holds the imaging lens; and
a flow adjustment protrusion that protrudes to a vehicle downward direction from a lower position of the imaging lens of the casing.

2. The vehicle imaging apparatus according to claim 1,
wherein a front end part of the flow adjustment protrusion is located at a vehicle rearward position further than a tangent line at a lowermost point of a lens surface approximation curve that has a constant curvature and that connects an uppermost point located at an uppermost position of an outer surface of the imaging lens, the lowermost point located at a lowermost position of the outer surface of the imaging lens, and an intermediate point located at a middle position between the uppermost point and the lowermost point of the outer surface of the imaging lens.

3. The vehicle imaging apparatus according to claim 1,
wherein the flow adjustment protrusion has a substantially triangular shape in a vehicle side view and has a substantially rectangular shape in a vehicle rear view.

4. The vehicle imaging apparatus according to claim 1,
wherein a surface that faces a vehicle frontward side of the flow adjustment protrusion is curved concavely toward a vehicle rearward direction from an upward direction to a downward direction.

5. The vehicle imaging apparatus according to claim 1,
wherein the flow adjustment protrusion is constituted of a separate component that is attachable to and detachable from the casing.

6. The vehicle imaging apparatus according to claim 1,
wherein the flow adjustment protrusion is constituted of an integral component with the casing.

7. The vehicle imaging apparatus according to claim 1,
wherein an eave part that protrudes in a vehicle rearward direction further than the outer surface of the imaging lens is arranged on a rear upper part of the casing.
